(19) United States
(12) Patent Application Publication
(10) Pub. No.: US 2019/0126576 A1
(43) Pub. Date: May 2, 2019

(54) LENS SHEET AND OPTICAL MODULE

(71) Applicant: FUJITSU COMPONENT LIMITED, Tokyo (JP)

(72) Inventor: Tatsuhiro Mori, Tokyo (JP)

(21) Appl. No.: 16/162,761

(22) Filed: Oct. 17, 2018

(30) Foreign Application Priority Data
Oct. 27, 2017 (JP) 2017-207829

(51) Int. Cl. B29D 11/00; B29C 43/18; B29C 35/08; G02B 3/00

(52) U.S. Cl. CPC B29D 11/0048; B29C 43/18; G02B 3/0031; B29C 35/0888; B29D 11/00298; B29D 11/0073

(57) ABSTRACT

A lens sheet includes a base made of transparent resin, a lens part formed on the base and having a convex lens, and a protrusion formed around the lens and having a height lower than a height of the lens. A gap is provided between the lens and the protrusion.

### CROSS-REFERENCE TO RELATED APPLICATIONS

This application is based on and claims priority to Japanese Patent Application No. 2017-207829, filed on Oct. 27, 2017 the entire contents of which are incorporated herein by reference.

### BACKGROUND OF THE INVENTION

### 1. Field of the Invention

The disclosures herein generally relate to a lens sheet and an optical module.

### 2. Description of the Related Art

A lens sheet including a glass substrate and lenses formed on the glass substrate and formed of a UV curable resin is known (see Patent Document 1, for example). This lens sheet is manufactured by applying the UV curable resin to the space between the glass substrate and a mold. Subsequently, after the UV curable resin is cured, the glass substrate and the UV curable resin are removed from the mold.

In the above-described method, if a flexible resin is used as a base, the base is bent when the lens sheet is being removed from the mold. As a result, stress is applied to bottom portions of the lenses, and thus cracks may be formed around the lenses.

### RELATED-ART DOCUMENTS

### Patent Documents

[Patent Document 1] International Publication Pamphlet No. WO2013/187515

### SUMMARY OF THE INVENTION

It is a general object of an embodiment of the present invention to provide a lens sheet that can prevent a crack from being formed around a lens.

According to an embodiment, a lens sheet includes a base made of transparent resin; a lens part formed on the base and having a convex lens; and a protrusion formed around the lens and having a height lower than a height of the lens.

### BRIEF DESCRIPTION OF THE DRAWINGS

FIGS. 1A through 1C are drawings illustrating a method for manufacturing a lens sheet;

FIGS. 2A and 2B are drawings illustrating cracks formed in the lens sheet;

FIGS. 3A and 3B are drawing illustrating a lens sheet according to a first embodiment;

FIGS. 4A through 4C are drawings illustrating an example in which stress is applied when the lens sheet is being removed from a mold.

FIGS. 5A through 5C are drawings illustrating an example in which stress is applied when the lens sheet is removed from the mold.

FIGS. 6A through 6C are drawings illustrating an example in which stress is applied when a lens sheet according to a comparative example is removed from a mold.

FIG. 7 is an exploded perspective view illustrating an optical module including the lens sheet according to the first embodiment;

FIG. 8 is a plan view of the optical module;

FIG. 9 is a cross-sectional view of the optical module;

FIGS. 10A and 10B are drawings illustrating a lens sheet according to a second embodiment;

FIGS. 11A and 11B are drawings illustrating a lens sheet according to a third embodiment;

FIGS. 12A and 12B are drawings illustrating a lens sheet according to a fourth embodiment;

FIGS. 13A and 13B are drawings illustrating a lens sheet according to a fifth embodiment;

FIGS. 14A and 14B are drawings illustrating a lens sheet according to a sixth embodiment; and

FIGS. 15A and 15B are drawings illustrating a lens sheet according to a seventh embodiment.

### DESCRIPTION OF THE PREFERRED EMBODIMENTS

In a lens sheet according to at least one embodiment, a protrusion formed around a lens can reduce stress that is applied when the lens sheet is being removed from a mold. Accordingly, it is possible to prevent a crack from being formed around the lens.

Embodiments of the present invention will be described with reference to the accompanying drawings. In the drawings, the same elements are denoted by the same reference numerals, and a duplicate description thereof may be omitted.

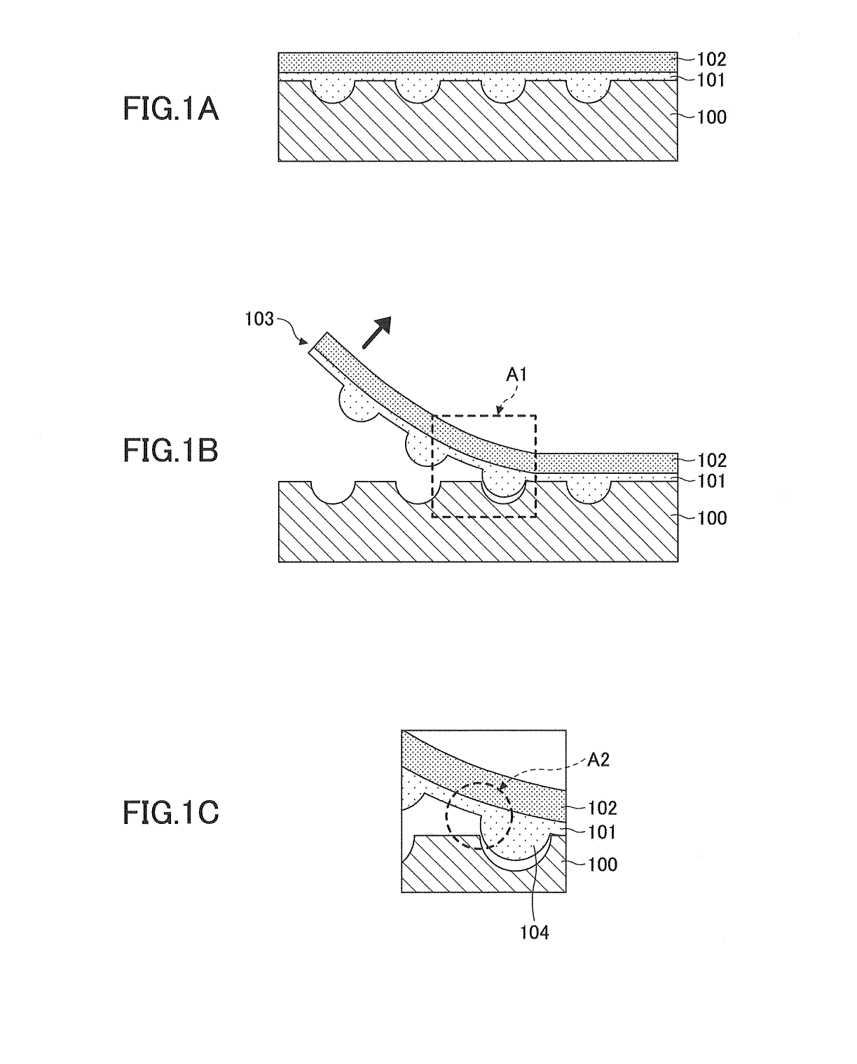

First, a crack formed around a lens will be described. Such a crack is formed in manufacturing a lens sheet that uses a transparent resin having flexibility as a base. FIGS. 1A through 1C are drawings illustrating a method for manufacturing a lens sheet. FIG. 1A and FIG. 1B are schematic cross-sectional views illustrating the method for manufacturing the lens sheet. FIG. 1C is an enlarged view of an area A1 of FIG. 1B. An arrow in FIG. 1B illustrates a direction in which the lens sheet is removed from a mold.

As illustrated in FIG. 1A, when manufacturing the lens sheet, a UV curable resin 101 is applied to a mold 100 first, and a base 102 made of resin is bonded to the resin 101. Next, the resin 101 is irradiated with ultraviolet light so as to cure the resin 101.

Next, as illustrated in FIG. 1B, a lens sheet 103 including the resin 101 and the base 102 is removed from the mold 100. At this time, as illustrated in FIG. 1B and FIG. 1C, the lens sheet 103 is bent. As a result, stress is applied to bottom portions of lenses 104 formed on the base 102, and thus cracks may be formed around the lenses 104. In FIG. 1C, a crack may be formed in an area A2. Also, cracks may be formed in areas other than the vicinities of the lenses 104 on the base 102.

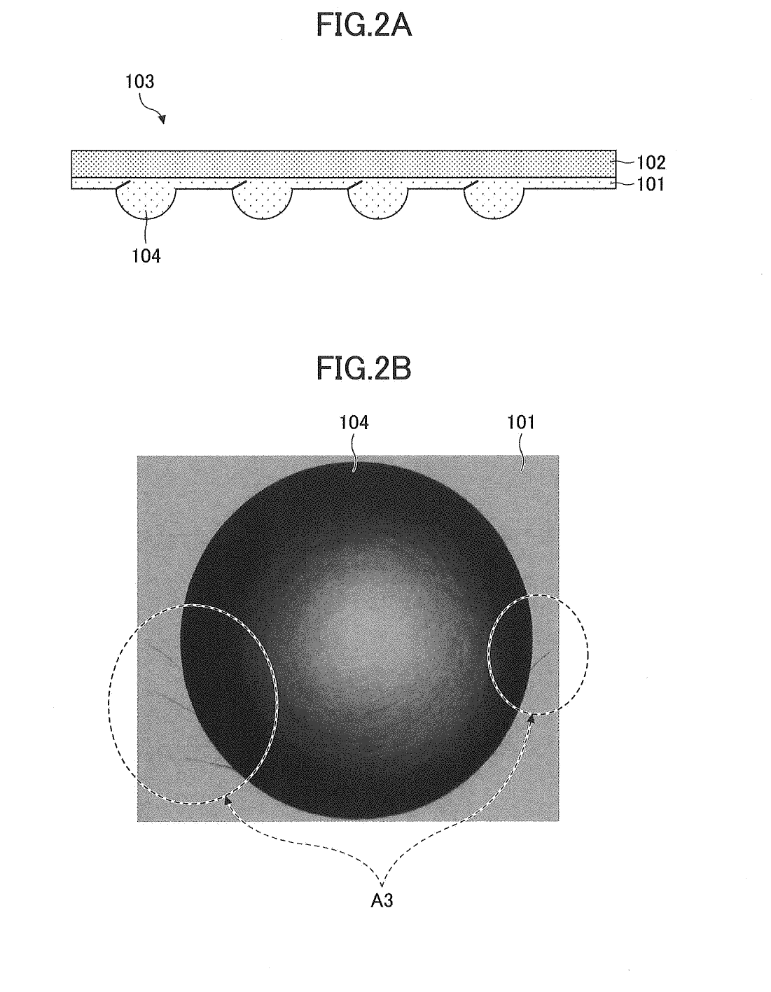

FIGS. 2A and 2B are drawings illustrating cracks formed in the lens sheet 103. FIG. 2A is a schematic cross-sectional view of the lens sheet 103 after the lens sheet 103 is removed from the left side to the right side of the mold 100. FIG. 2B is a micrograph of the lens sheet 103.

As illustrated in FIG. 2A, when the lens sheet 103 that uses the base 102 made of flexible resin is manufactured, cracks may be formed in the lens sheet 103. As illustrated in FIG. 2B, cracks are likely to be formed on sides of areas A3 from which the lens sheet 103 starts to be removed. When cracks are formed around the lenses 104, the lenses 104 may be peeled from the base 102. Thus, the reliability of the lens sheet 103 decreases.

In the following embodiments, a lens sheet capable of preventing cracks from being formed around lenses will be described.

### First Embodiment

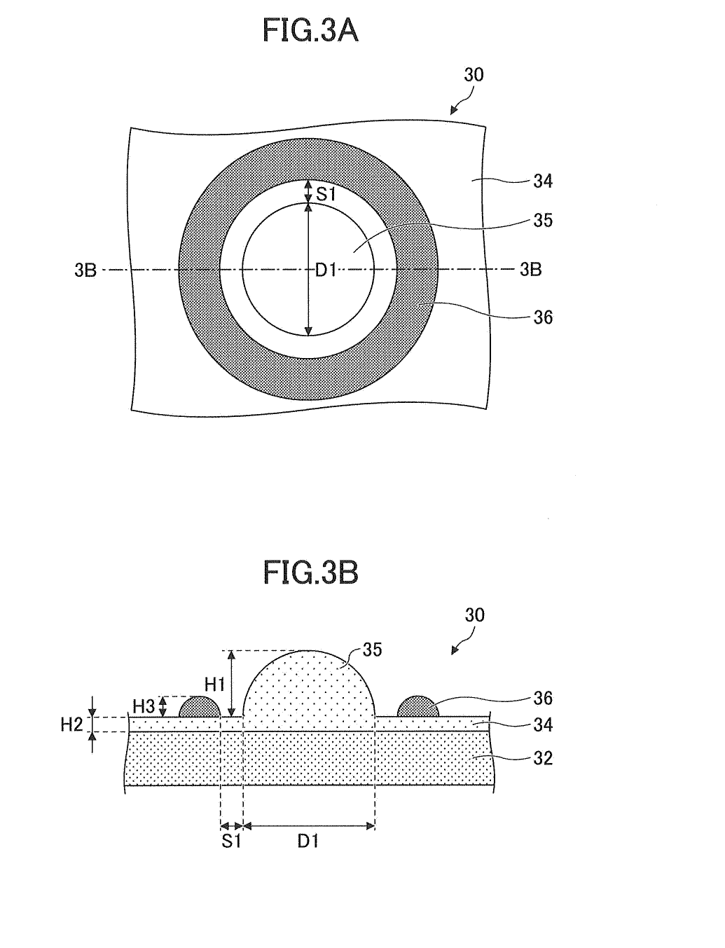

A lens sheet according to a first embodiment will be described. FIGS. 3A and 3B are drawings illustrating the lens sheet according to the first embodiment. FIG. 3A is a plan view of the lens sheet. FIG. 3B is a cross-sectional view of the lens sheet taken through the dashed-dotted line 3B-3B of FIG. 3A.

As illustrated in FIGS. 3A and 3B, a lens sheet 30 includes a transparent base 32, a lens part 34, and a protrusion 36.

The base 32 is made of resin having transparency and flexibility. For example, the resin is polycarbonate.

The lens part 34 is formed on the base 32. At least one convex lens 35 is formed on the upper surface of the lens part 34. The lens 35 may be a spherical lens or an aspherical lens. A diameter D1 of the lens 35 is 100 μm, a height H1 of the lens 35 is 30 μm, and a thickness H2 of a part of the lens part 34 on which the lens 35 is not formed is a few μm, for example.

The protrusion 36 is formed on the lens part 34 in a circular shape so as to surround the lens 35. A height H3 of the protrusion 36 is preferably lower than the height H1 of the lens 35, and is preferably equal to or less than half the height H1, for example. With H1>H3, the protrusion 36 can prevent the lens part 34 from cracking when the lens sheet 30 is being removed from the mold 38. In order to reduce stress, the protrusion 36 is preferably disposed spaced apart from the lens 35 by a gap S1. The protrusion 36 and the lens 35 are preferably formed of the same material. When the protrusion 36 and the lens 35 are formed of the same material, the lens 35 and the protrusion 36 can be simultaneously formed by using a single mold. Thus, labor-hours required to manufacture the lens sheet 30 can be reduced. Further, no position matching is required if the lens 35 and the protrusion 36 are integrally formed, unlike a case in which plural molds are used to manufacture the lens sheet 30.

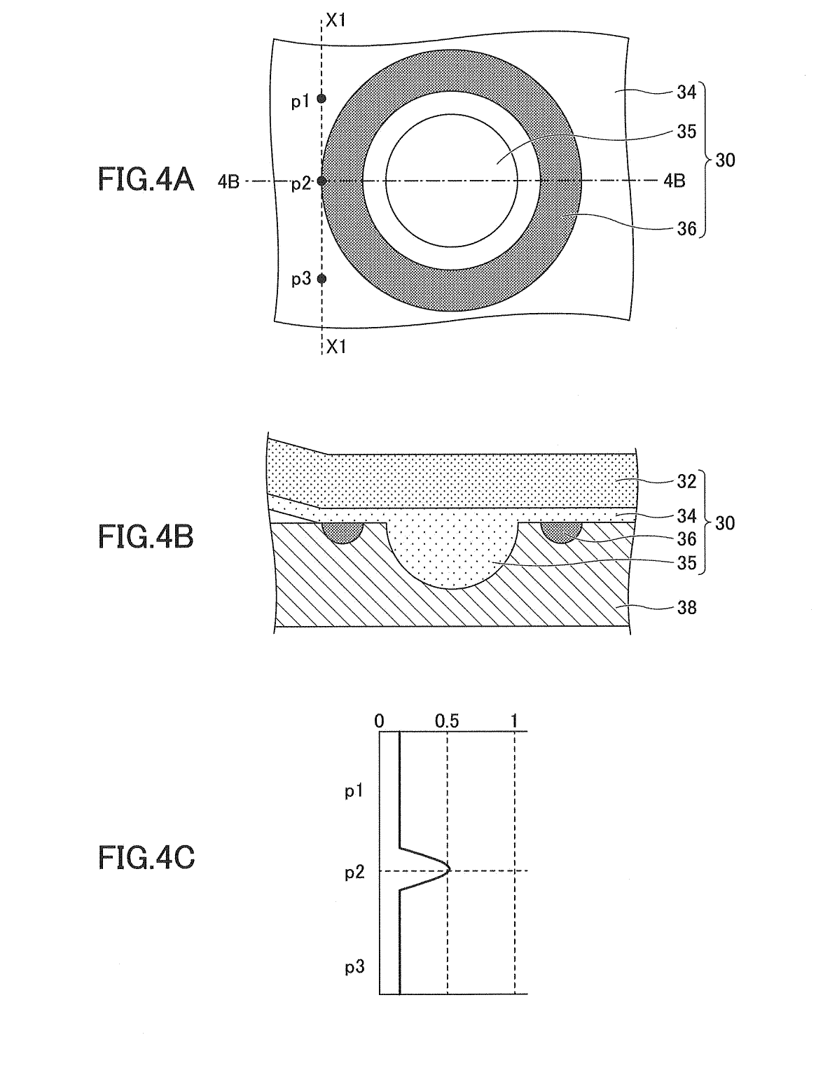

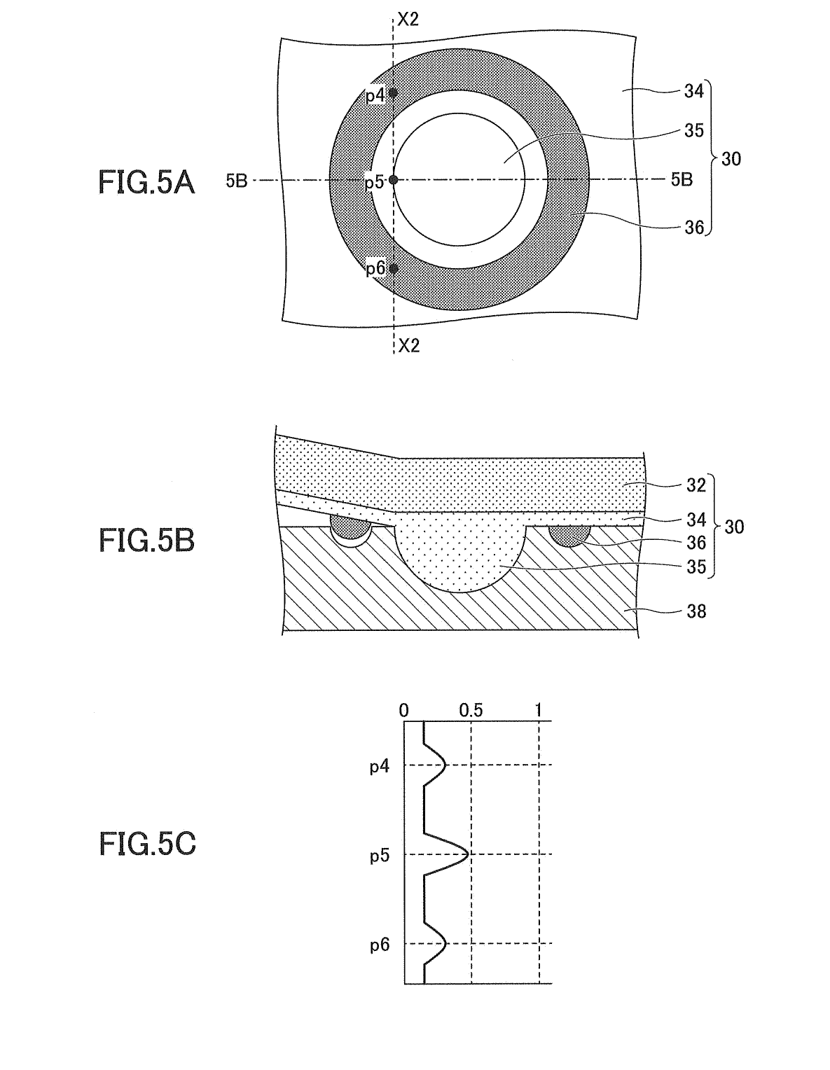

FIGS. 4A through 4C and FIGS. 5A through 5C are drawings illustrating examples in which stress is applied when the lens sheet 30 is being removed from the mold 38. FIG. 4A is a plan view of the lens sheet 30. FIG. 4B is a cross-sectional view of the lens sheet 30 taken through 4B-4B of FIG. 4A. In FIG. 4B, the lens sheet 30 is removed from the mold 38 up to a line X1-X1 of FIG. 4A. FIG. 4C is a drawing indicating stress applied to the lens sheet at positions on the line X1-X1 of FIG. 4A. A vertical axis indicates the positions on the line X1-X1 and a horizontal axis indicates relative stress.

When the lens sheet 30 has been removed from the mold 38 up to a position where the protrusion 36 is formed, the largest stress is applied to the lens sheet 30 at a position p2 where the protrusion 36 is formed, as illustrated in FIG. 4C. At this time, the stress applied at the position p2 is approximately 0.5.

FIG. 5A is a plan view of the lens sheet 30. FIG. 5B is a cross-sectional view of the lens sheet 30 taken through 5B-5B of FIG. 5A. In FIG. 5B, the lens sheet 30 has been removed from the mold 38 up to a line X2-X2 of FIG. 5A. FIG. 5C is a drawing indicating stress applied to the lens sheet 30 at positions on the line X2-X2 of FIG. 5A. A vertical axis indicates the positions on the line X2-X2 and a horizontal axis indicates relative stress.

When the lens sheet 30 has been removed from the mold 38 up to a position where the lens 35 is formed, stress is applied to the lens sheet 30 at a position p5 where the lens 35 is formed. Stress is also applied to the lens sheet 30 at positions p4 and p6. At this time, the stress applied at the position p4 is approximately 0.3, the stress applied at the position p5 is approximately 0.5, and the stress applied at the position p6 is approximately 0.3.

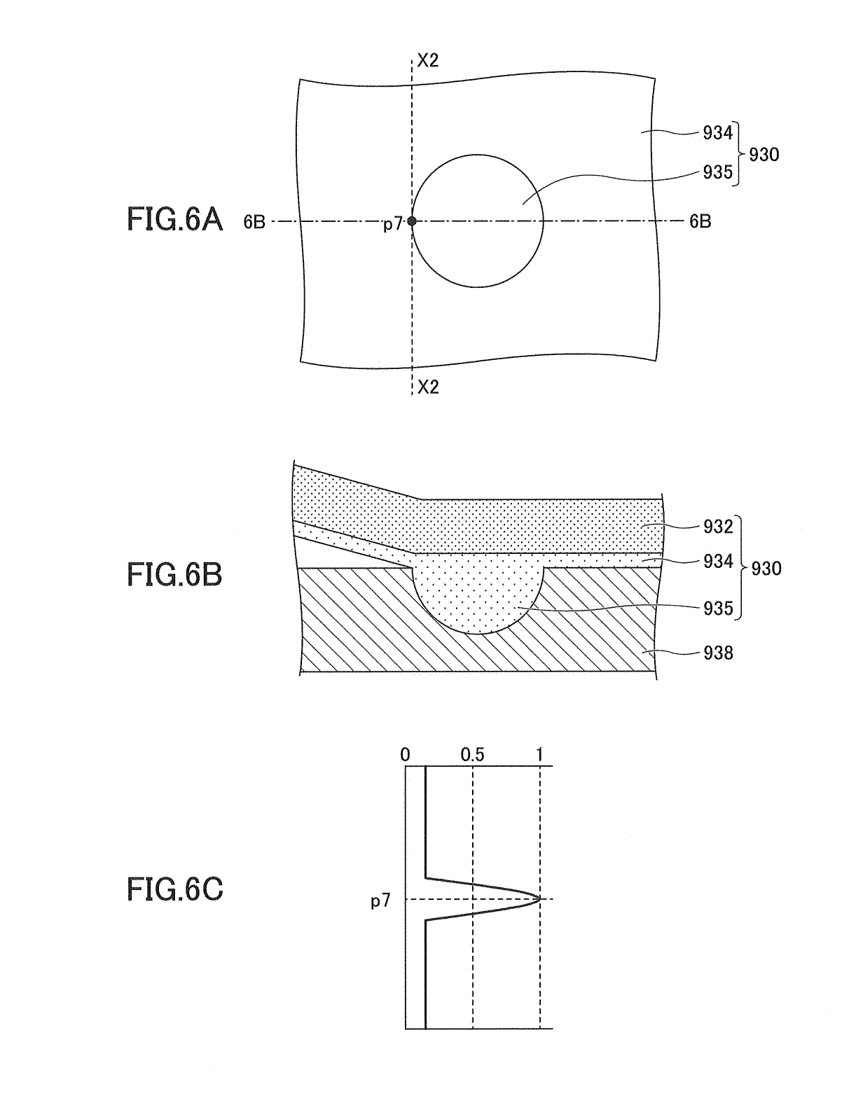

FIGS. 6A through 6C are drawings illustrating an example in which stress is applied when a lens sheet 930 according to a comparative example is being removed from a mold 938. FIG. 6A is a plan view of the lens sheet 930. FIG. 6B is a cross-sectional view of the lens sheet 930 taken through 6B-6B of FIG. 6A. In FIG. 6B, the lens sheet 930 has been removed from the mold 938 up to a line X2-X2 of FIG. 6A. FIG. 6C is a drawing indicating stress applied to the lens sheet 930 at positions on the line X2-X2 of FIG. 6A. A vertical axis indicates the positions on the line X2-X2 and a horizontal axis indicates relative stress.

When the lens sheet 930 has been removed from the mold 938 up to a position where the lens 935 is formed, the largest stress is applied to the lens sheet 930 at a position p7 where the lens 35 is formed. At this time, the stress applied at the position p7 is approximately 1.0. The stress applied to the lens sheet 930 is twice the stress applied to the lens sheet 30 according to the first embodiment illustrated in FIG. 5C.

In the first embodiment, the protrusion 36 formed around the lens 35 can reduce stress that is applied when the lens sheet 30 is being removed from the mold. As a result, it is possible to prevent a crack from being formed around the lens 35.

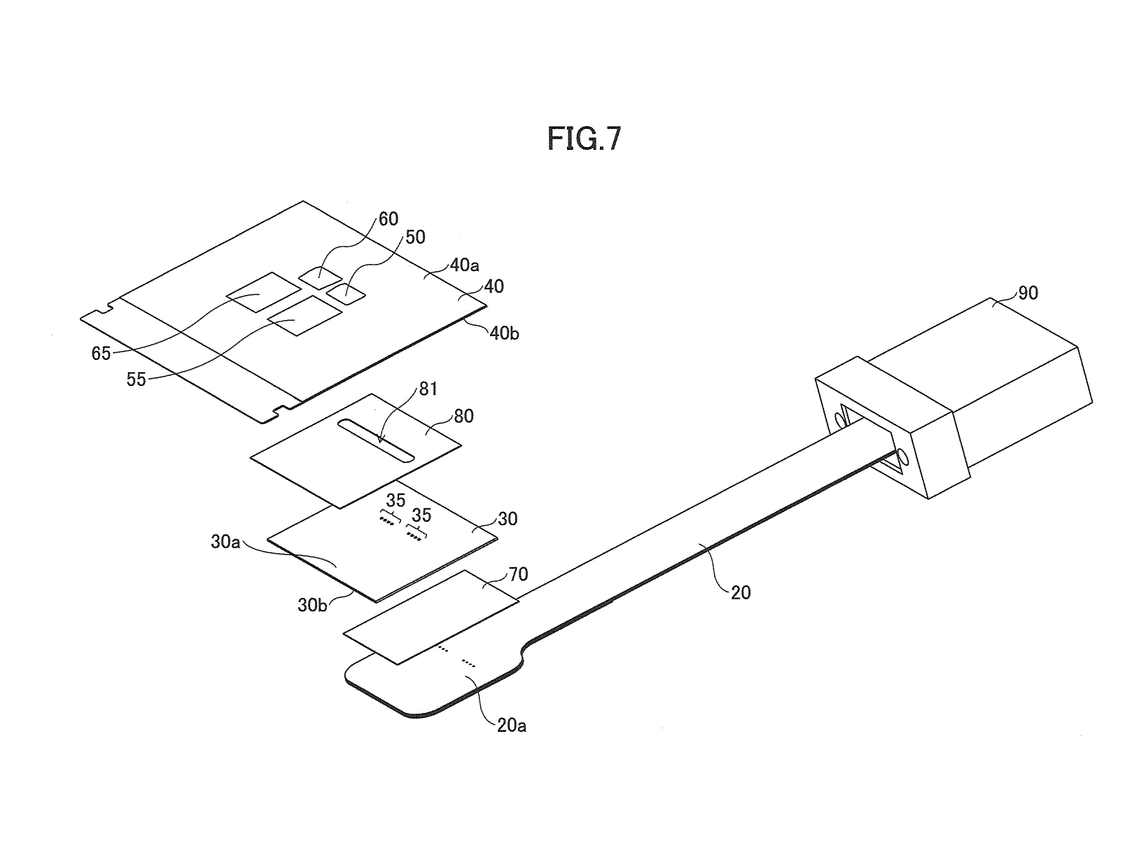

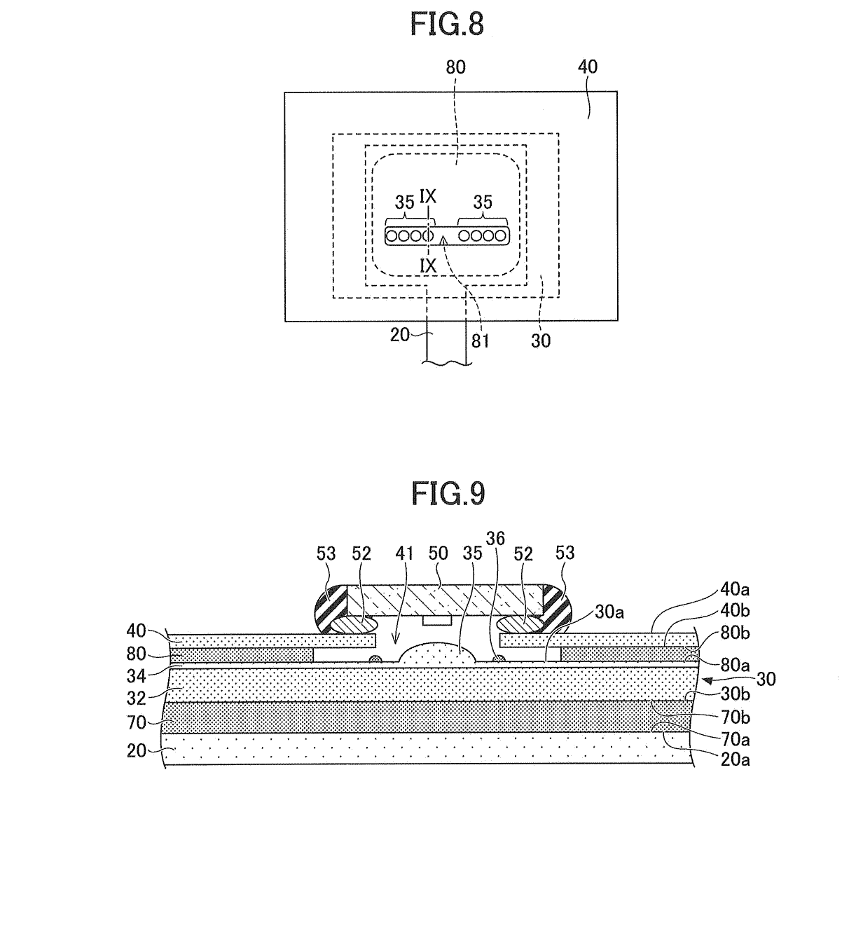

Next, an optical module including the lens sheet 30 will be described. FIG. 7 is an exploded perspective view illustrating the optical module including the lens sheet 30. FIG. 8 is a plan view of the optical module.

In the optical module illustrated in FIG. and FIG. 8, the lens sheet 30 and a flexible substrate (FPC) 40 are stacked above a sheet-shaped optical waveguide 20.

The optical waveguide 20 includes a core confined between cladding layers. A ferrule 90 with a lens is connected to the optical waveguide 20. A mirror (not illustrated) is formed at the other end of the optical waveguide 20 by removing a part of the waveguide 20 in a V shape. A surface 30a of the lens sheet 30 is provided with lenses 35 aligned at equal intervals. A surface 30b of the lens sheet 30 is bonded to the optical waveguide 20 by an adhesive sheet 70.

A light emitter 50, a light receiver 60, a driver 55, and a TIA (transimpedance amplifier) 65 are mounted on a surface 40a of the FPC 40. The light emitter 50 has a plurality of light-emitting portions, and is a vertical-cavity surface-emitting laser (VCSEL), for example. The light receiver 60 has a plurality of light-receiving portions, and is a photodiode, for example. The driver 55 is an integrated circuit (IC) that drives the light emitter 50. The TIA 65 is an IC that converts an electrical current generated by light detected by the light receiver 60 into voltage. The light emitter 50, the light receiver 60, the driver 55, and the TIA 65 are mounted on the FPC 40 through bumps, although not illustrated.

The FPC 40 has through-holes disposed in paths of light for light emitted from the light emitter 50 and light incident on the light receiver 60. Further, a surface 40b of the FPC 40 is bonded to the lens sheet 130 by an adhesive sheet 80. The adhesive sheet 80 has a through-hole 81 disposed in the paths of light. The adhesive sheets 70 and 80 are transparent double-sided adhesive tapes.

FIG. 9 is a cross-sectional view of the optical module taken through the dashed-dotted line IX-IX of FIG. 8.

As illustrated in FIG. 9, the lens sheet 30 includes the base 32, the lens part 34 including the lens 35, and the protrusion 36. The adhesive sheet 80 is bonded to the surface 30a of the lens sheet 30. The FPC 40 is bonded to the adhesive sheet 80. The height of the protrusion 36 is smaller than the thickness of the adhesive sheet 80. For example, the height of the protrusion 36 is preferably equal to or less than half the height of the lens 35 as described above. By making the height of the protrusion 36 smaller than the thickness of the adhesive sheet 80, it is possible to prevent the protrusion 36 from coming into contact with the FPC 40.

The light emitter 50 is coupled to the surface 40a through bumps 52. Sides of the bumps 52 and of the light emitter 50 are covered by side-fill 53. Although not illustrated, the light receiver 60 is coupled to the surface 40a through bumps, and sides of the bumps and of the light receiver 60 are covered by side-fill similarly to the above. The FPC 40 has through-holes 41 disposed in paths of light for light emitted from the light emitter 50 and light incident on the light receiver 60. Further, the adhesive sheet 70 is bonded to the waveguide 20. The lens sheet 30 is bonded to the adhesive sheet 70.

As described, in the first embodiment, the optical module includes the lens sheet 30 that prevents a crack from being formed around the lens 35. Thus, even if the optical module is used for a long period of time, the lens part 34 is not readily peeled from the base 32. Accordingly, the long-term reliability of the optical module increases.

### Second Embodiment

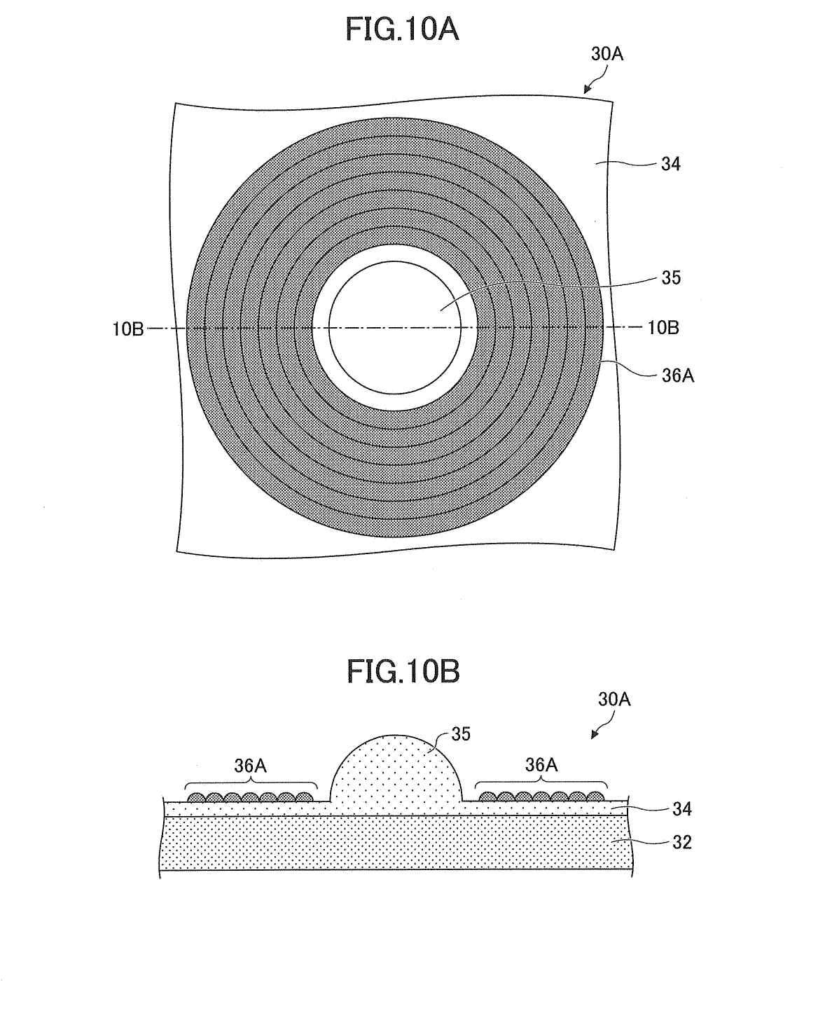

A lens sheet according to a second embodiment will be described. FIGS. 10A and 10B are drawings illustrating the lens sheet according to the second embodiment. FIG. 10A is a plan view of the lens sheet. FIG. 10B is a cross-sectional view of the lens sheet taken through the dashed-dotted line 10B-10B of FIG. 10A.

As illustrated in FIGS. 10A and 10B, a lens sheet 30A according to the second embodiment includes a plurality of (in FIGS. 10A and 10B, seven) circular-shaped protrusions 36A formed around the lens 35. The protrusions 36A are each continuously formed without any gap therebetween. Other elements are the same as those of the lens sheet 30 according to the first embodiment.

In the second embodiment, the protrusions 36A formed around the lens 35 can reduce stress that is applied to the lens 35 when the lens sheet 30A is being removed from the mold. As a result, it is possible to prevent a crack from being formed around the lens 35.

### Third Embodiment

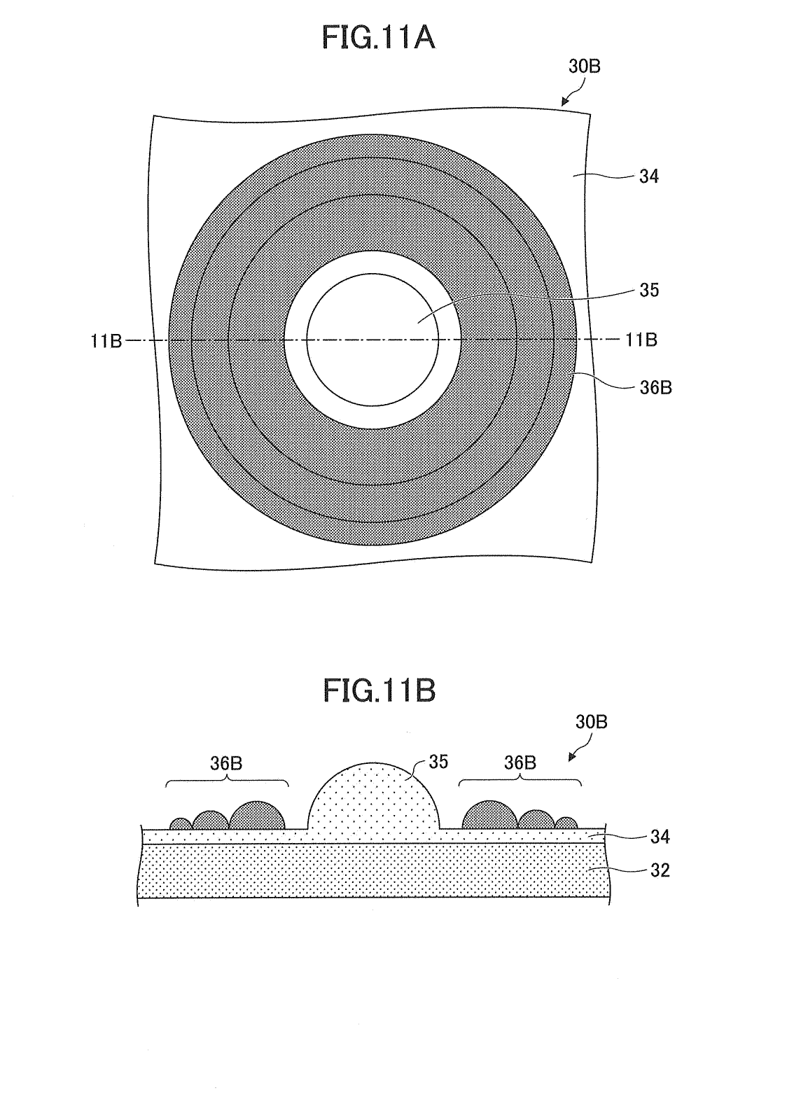

A lens sheet according to a third embodiment will be described. FIGS. 11A and 11B are drawings illustrating the lens sheet according to the third embodiment. FIG. 11A is a plan view of the lens sheet. FIG. 11B is a cross-sectional view of the lens sheet taken through the dashed-dotted line 11B-11B of FIG. 11A.

As illustrated in FIGS. 11A and 11B, a lens sheet 30B according to the third embodiment includes a plurality of (in FIGS. 11A and 11B, three) circular-shaped protrusions 36B whose heights become lower in order from the nearest to the lens 35 to the farthest. Other elements are the same as those of the lens sheet 30A according to the second embodiment.

In the third embodiment, the protrusions 36B formed around the lens 35 can reduce stress that is applied when the lens sheet 30B is being removed from the mold. As a result, it is possible to prevent a crack from being formed around the lens 35.

### Fourth Embodiment

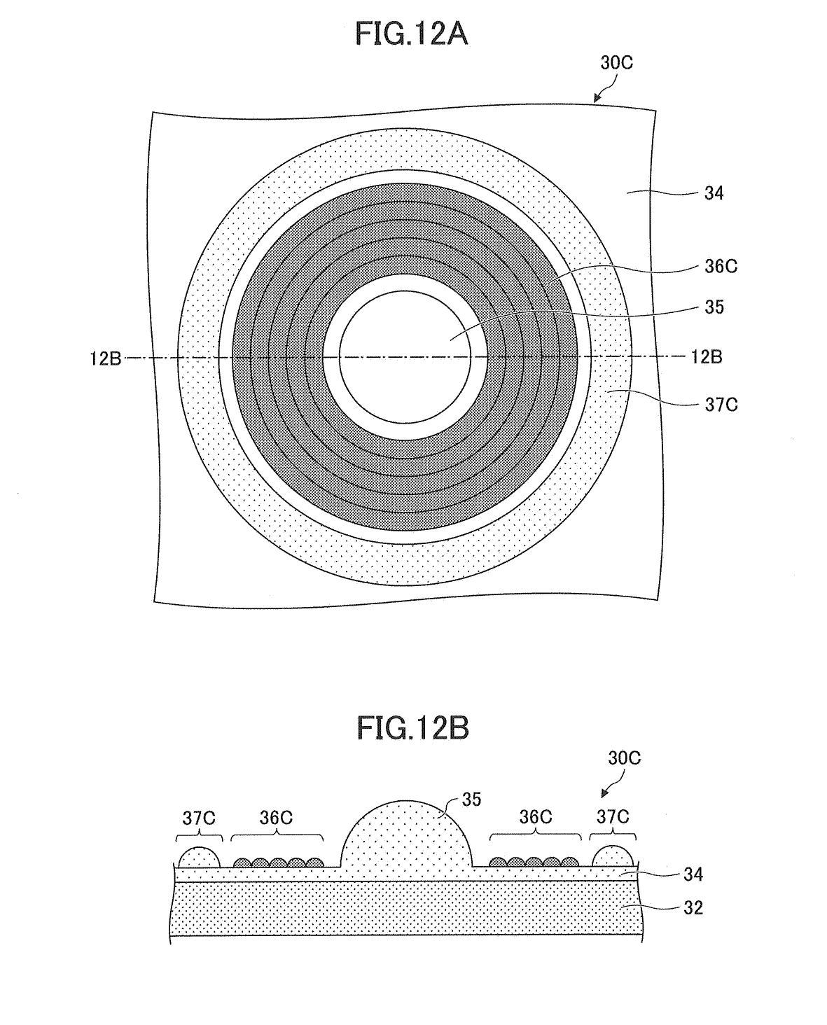

A lens sheet according to a fourth embodiment will be described. FIGS. 12A and 12B are drawings illustrating the lens sheet according to the fourth embodiment. FIG. 12A is a plan view of the lens sheet. FIG. 12B is a cross-sectional view of the lens sheet taken through the dashed-dotted line 12B-12B of FIG. 12A.

As illustrated in FIGS. 12A and 12B, a lens sheet 30C according to the fourth embodiment includes a plurality of (in FIGS. 12A and 12B, five) continuously formed circular first protrusions 36C and a second protrusion 37C disposed spaced apart from and outside the first protrusions 36C. Other elements are the same as those of the lens sheet 30A according to the second embodiment.

In the fourth embodiment, the first protrusions 36C and the second protrusion 37C formed around the lens 35 can reduce stress that is applied to the lens 35 when the lens sheet 30C is being removed from the mold. As a result, it is possible to prevent a crack from being formed around the lens 35.

The lens sheet 30C may be bonded to the optical waveguide and the flexible substrate with use of image recognition of the lens 35. At this time, because the second protrusion 37C is disposed spaced apart from the first protrusions 36C, pattern recognition improves as compared to when protrusions are continuously disposed.

### Fifth Embodiment

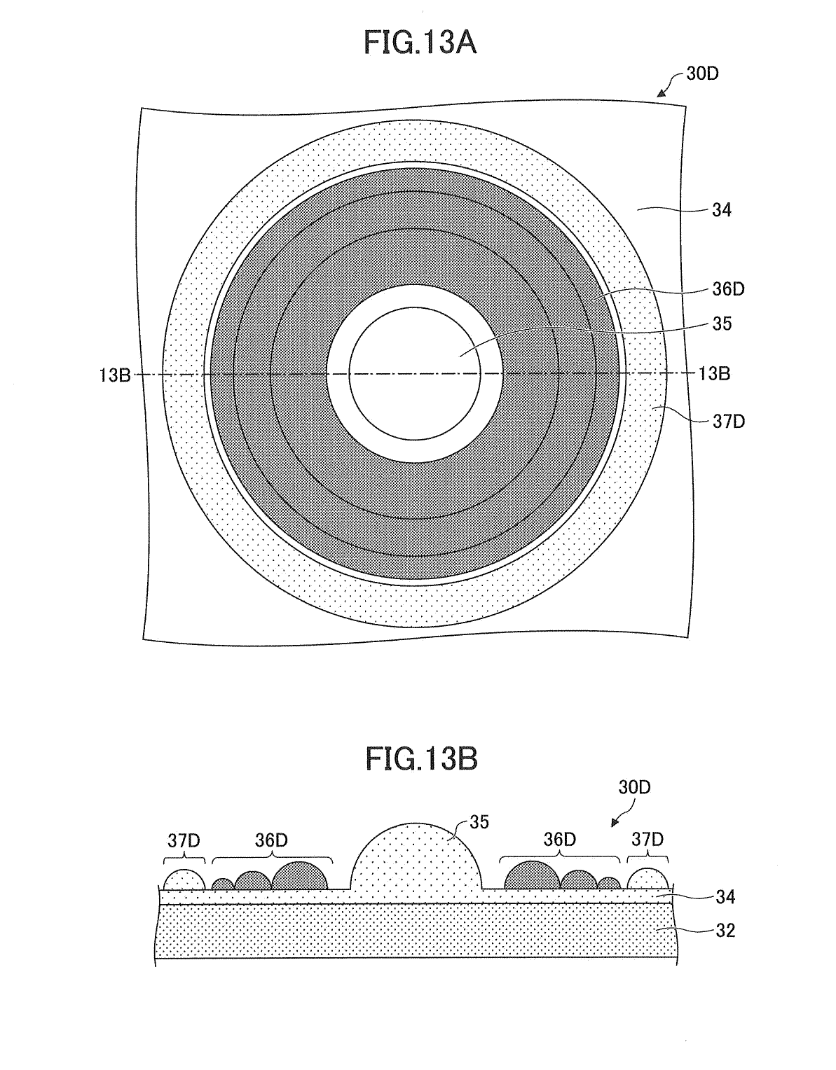

A lens sheet according to a fifth embodiment will be described. FIGS. 13A and 13B are drawings illustrating the lens sheet according to the fifth embodiment. FIG. 13A is a plan view of the lens sheet. FIG. 13B is a cross-sectional view of the lens sheet taken through the dashed-dotted line 13B-13B of FIG. 13A.

As illustrated in FIGS. 13A and 13B, a lens sheet 30D according to the fifth embodiment includes a plurality of (in FIGS. 13A and 13B, three) continuously formed circular first protrusions 36D and a second protrusion 37D disposed spaced apart from the first protrusions 36D. Similarly to the protrusions 36B according to the third embodiment, heights of the first protrusions 36D become lower in order from the nearest to the lens 35 to the farthest. Other elements are the same as those of the lens sheet 30B according to the third embodiment.

In the fifth embodiment, similarly to the first embodiment, the first protrusions 36D and the second protrusion 37D formed around the lens 35 can reduce stress that is applied when the lens sheet 30D is being removed from the mold. As a result, it is possible to prevent a crack from being formed around the lens 35.

Further, if the lens sheet 30D is bonded to the optical waveguide and the flexible substrate with use of image recognition of the lens 35, pattern recognition improves as compared to when protrusions are continuously disposed because the second protrusion 37D is disposed spaced apart from the first protrusions 36D.

### Sixth Embodiment

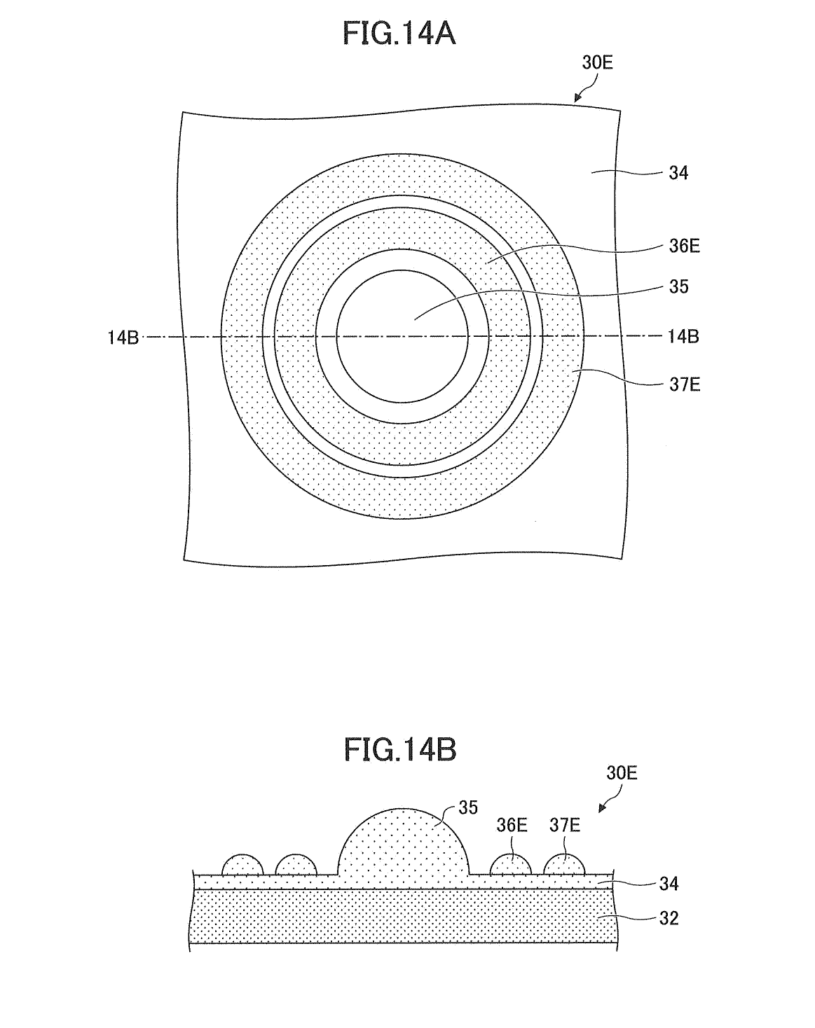

A lens sheet according to a sixth embodiment will be described. FIGS. 14A and 14B are drawings illustrating the lens sheet according to the sixth embodiment. FIG. 14A is a plan view of the lens sheet. FIG. 14B is a cross-sectional view of the lens sheet taken through the dashed-dotted line 14B-14B of FIG. 14A.

As illustrated in FIGS. 14A and 14B, a lens sheet 30E according to the sixth embodiment includes a first protrusion 36E and a second protrusion 37E, which are disposed spaced apart from each other around the lens 35. The second protrusion 37E may have a height same as or different from that of the first protrusion 36E.

In the sixth embodiment, similarly to the first embodiment, the first protrusion 36E and the second protrusion 37E formed around the lens 35 can reduce stress that is applied when the lens sheet 30E is being removed from the mold. As a result, it is possible to prevent a crack from being formed around the lens 35.

Further, if the lens sheet 30E is bonded to the optical waveguide and the flexible substrate with use of image recognition of the lens 35, because the second protrusion 37E is disposed spaced apart from the first protrusion 36E, pattern recognition improves.

### Seventh Embodiment

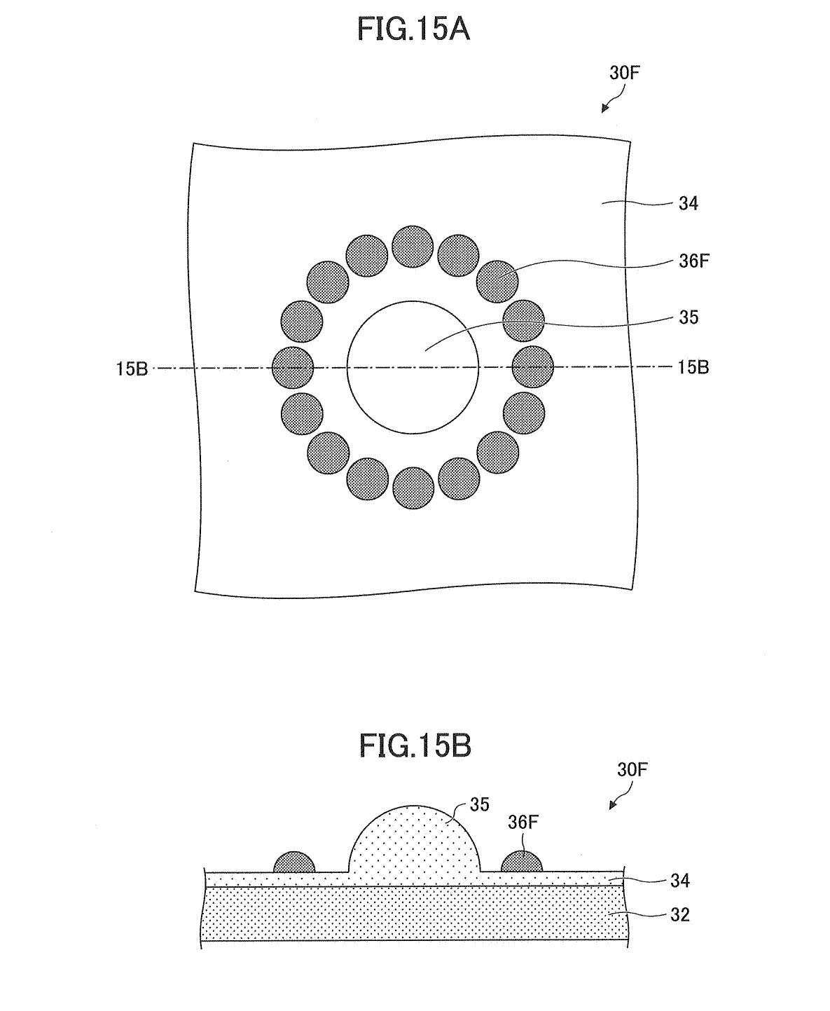

A lens sheet according to a seventh embodiment will be described. FIGS. 15A and 15B are drawings illustrating the lens sheet according to the seventh embodiment. FIG. 15A is a plan view of the lens sheet. FIG. 15B is a cross-sectional view of the lens sheet taken through the dashed-dotted line 15B-15B of FIG. 15A.

As illustrated in FIGS. 15A and 15B, a lens sheet 30F according to the seventh embodiment includes a plurality of dot-shaped protrusions 36F. The protrusions 36F are disposed spaced apart from each other following a circumferential direction of a circle concentric with the lens 35. In FIGS. 15A and 15B, sixteen protrusions 36F are disposed around the lens 35. Other elements are the same as those of the lens sheet 30 according to the first embodiment.

In the seventh embodiment, similarly to the first embodiment, the protrusions 36F formed around the lens 35 can reduce stress that is applied when the lens sheet 30F is being removed from the mold. As a result, it is possible to prevent a crack from being formed around the lens 35.

In the seventh embodiment, the dot pattern protrusions 36F can be formed by using the same method as the lens 35. Accordingly, an effect of having high mold manufacturability can be obtained.

Although the embodiments have been specifically described above, the present invention is not limited to the above-described embodiments. Various variations and modifications may be made without departing from the scope of the present invention.

What is claimed is:

1. A lens sheet comprising:
a base made of transparent resin;
a lens part formed on the base and having a convex lens; and
a protrusion formed around the lens and having a height lower than a height of the lens.

2. The lens sheet according to claim 1, wherein the protrusion is formed in a circular shape.

3. The lens sheet according to claim 1, wherein a gap is provided between the lens and the protrusion.

4. An optical module comprising:
a sheet-shaped optical waveguide;
the lens sheet according to claim 1 disposed above the optical waveguide; and
a flexible substrate disposed above the lens sheet.
